(19) United States
(12) Patent Application Publication
(10) Pub. No.: US 2004/0245496 A1
(43) Pub. Date: Dec. 9, 2004

(54) Cleaning agent, antibacterial material, environment clarifying material, functional adsorbent

(76) Inventor: Hiroshi Taoda, Aichi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/490,853

(22) PCT Filed: Sep. 27, 2002
(86) PCT No.: PCT/JP02/10095

(30) Foreign Application Priority Data
Sep. 27, 2001 (JP) 2001-295463
Sep. 27, 2001 (JP) 2001-295472
Sep. 27, 2001 (JP) 2001-295481
Sep. 27, 2001 (JP) 2001-295488

(51) Int. Cl. C01B 11/00

(52) U.S. Cl. 252/186.1

(57) ABSTRACT

The present invention provides a novel cleaning agent comprising at least one member of the group consisting of TiOₓ (1.5<x<2), TiOₓN₂₋ₓ (1<x<2), diamond-like carbon, and a titania-silica complex TiOₓ—SiO₂ (1.5<x≦2), and method for cleaning objects with said cleaning agent. The present invention further provides an antibacterial material containing the above-mentioned materials, an antibacterial product featuring the same, a method for manufacturing an environmental material, a novel functional adsorbent, and a method for manufacturing the same.

### TECHNICAL FIELD

This invention relates to a cleaning agent and a cleaning method for decomposing and removing soil adhering to an object, thereby cleaning the object, and more particularly relates to a novel cleaning agent with which soil adhering to a variety of objects, such as buildings or building materials, jewelry, teeth, or dentures, can be easily decomposed and removed and the object thereby cleaned, and to a method for cleaning various types of object with said cleaning agent.

The present invention also relates to an antibacterial material and to an antibacterial product in which this antibacterial material is used, and more particularly to an antibacterial material and an antibacterial product that not only suppress the proliferation of bacteria living on the surface of an object or in the air or water, but also have the action of decomposing these bacteria, rendering them harmless, and removing them.

The present invention also relates to an environmental clarifying material having an excellent environmental cleaning action, and more particularly to a method for manufacturing an environmental material having such functions as removing unpleasant odors, decomposing and removing harmful substances and contaminants in the air, treating wastewater, purifying water, sterilizing water, and so forth. For instance, the present invention relates to a method for manufacturing an environmental material that can be used favorably by being added (such as by kneading) to organic fibers or plastics.

The present invention further relates to a novel functional adsorbent having the action of adsorbing and decomposing substances, and more particularly to a novel functional adsorbent that not only adsorbs unpleasant odors and harmful substances in the air, but also has the action of decomposing these or rendering them harmless, and removing them, by a photocatalytic action.

### BACKGROUND ART

A method in which soil is washed off with a detergent or the like has been the conventional approach to removing soils from various objects, such as the exterior walls of buildings, and thereby making these objects more attractive. This method, however, involves the use of chemical substances such as surfactants, and these substances can pollute rivers and lakes and cause serious problems such as “environmental hormones.” More recently there has been developed a method in which soil adhering to the exterior walls of a building or the like is removed with an agent contained in a pack. However, this method results in the wasteful use of resources because the pack often contains more agent than necessary for the soil. Another method for cleaning away soil is to mechanically scrape it off, but the problem with this method is that it consumes a large amount of energy. Antifouling paints and so forth that make use of photocatalysts have also been developed recently, but these prevent soil from adhering, or make it difficult for soil to adhere, and have the drawback that it is difficult to remove soil that has already adhered (see, for example, (1) Y. Saeki, Kaiho Hikarishokubai, Vol. 1, 83 (2000), and (2) N. Sendota, Kogyo Zairyo, Vol. 49, No. 7, 45 (2001)).

As discussed above, conventional cleaning methods most often entailed the use of harmful substances and/or the wasteful use of resources or energy. Consequently, there has been an urgent need in this field for the development of some way to clean away soils which would be safe and easy and would conserve resources and energy.

Also, as buildings have become more airtight in recent years in an effort to enhance heating and cooling efficiency and to utilize energy more effectively, there has been a growing problem with contamination by bacteria and mildew in the living environment, and this has been linked to an increase in the number of allergy patients suffering from asthma, atopy, and so forth. Other serious social problems include nosocomial infection caused by MRSA (methicillin resistant Staphylococcus aureus) in hospitals, mass infection caused by pathogenic E. coli such as O-157, and infection of Legionnaires' disease caused by Legionella in 24-hour baths, among others.

Organic chemical substances have long been used as antibacterial agents that inhibit the proliferation of these microbes, and a wide variety of types are available, such as those based on alcohols, phenols, aldehydes, carboxylic acids, esters, ethers, nitrites, peroxide-epoxies, halogens, and organometals. These are basically toxic, and most are elutable, so while they do offer good antibacterial and bactericidal strength, they can irritate the skin, and may lead to allergies, “sickhouse syndrome,” hypersensitivity to chemical substances, and so forth, so there are problems with the safety of these chemicals in terms of skin irritation, skin allergies, and so on. Therefore, care must be taken in the use of these chemicals with regard to their safety to humans and ecosystems. Also, because most of the existing antibacterial agents prevent bacterial growth or kill bacteria by releasing their effective component through elution or the like, the efficacy thereof decreases with time, to the point that the product can no longer be used.

When irradiated with light, titanium oxide produces electrons with a powerful reductive action and holes with a powerful oxidative action, and decomposes any molecular species with which it comes into contact by a redox action. This action of titanium oxide, namely, its photocatalytic action, can be utilized to inhibit the proliferation of microbes or kill microbes. This method has the advantages that it can be repeated over and over merely by utilizing titanium oxide and light, the reaction products are harmless carbon dioxide and so on, and titanium dioxide itself is a safe and nontoxic substance, so it affords safe and easy antibacterial action, and in principle it can be used semi-permanently.

However, a drawback to titanium oxide is that it has a large bandgap and will not undergo a photocatalytic reaction unless UV rays are involved, and therefore undergoes almost no reaction under electric lights. Also, if titanium oxide is mixed into a paint or other organic material, its powerful photocatalytic action can decompose not only microbes but even the paint itself, so these products cannot be used repeatedly or over extended periods.

Other issues that have become more serious problems in recent years include odors in living and work spaces, and pollution by harmful substances such as automotive exhaust gases. Water pollution, both industrial and non-industrial, and particularly the pollution of water sources by agrochemical used on golf course and organic chlorine-based solvents, which are difficult to treat with existing water treatment methods such as an active sludge method, has become very widespread, and environmental pollution by these substances has become a major social concern.

One method commonly performed to remove harmful substances from the air or to prevent unpleasant odors is to absorb them into an absorbent liquid such as an acid or alkali or to adsorb them into an adsorbent, but a problem with this method is how to dispose of the waste liquid or used adsorbent, which can result in secondary pollution. Another drawback is the possibility that the odor of perfumes will be transferred to a food, so that the food is damaged by the smell of the perfume itself (see, for example, (3) Konosuke Nishida, Heibonsha “Encyclopedia,” Vol. 1, p. 136 (1984)).

When irradiated with light, titanium oxide produces electrons with a powerful reductive action and holes with a powerful oxidative action, and decomposes any molecular species with which it comes into contact by a redox action. This action of titanium oxide, namely, its photocatalytic action, can be utilized to decompose and remove organic solvents, agrochemical, surfactants, and the like dissolved in water. This method has the advantages that it can be repeated over and over merely by utilizing titanium oxide and light, the reaction products are harmless carbon dioxide and so on, there are fewer restrictions on the reaction conditions, such as temperature, pH, gas atmosphere, and toxicity, than with such methods as biological treatment using microbes, and furthermore, even organic halogen compounds, organic phosphorus compounds, and other such compounds that are difficult to treat with methods such as biological treatment can be easily decomposed and removed.

However, titanium oxide was used directly in the form of a powder as a photocatalyst in research conducted up to now into the decomposition and removal of organic matter with a titanium oxide photocatalyst (see, for example, (4) A. L. Pruden and D. F. Ollis, Journal of Catalysis, Vol. 82, 404 (1983), (5) H. Hidaka, H. Jou, K. Nohara, and J. Zhao, Chemosphere, Vol. 25 1589 (1992), and (6) Teruaki Hisanaga, Kenji Harada, and Keiichi Tanaka, Kogyo Yosui [Industrial-use Water], No. 379, 12 (1990)). As a result, such powders were difficult to handle (e.g., recovery of the used photocatalyst was difficult) and could not really be put to practical use.

Accordingly, there have been attempts at kneading a titanium oxide photocatalyst into a medium that is easier to handle, such as fiber or plastic, but since the powerful photocatalytic action not only is exerted on harmful organic matter or environmental pollutants, but also results in the fiber or plastic itself tending to decompose and be severely degraded, it has been impossible to use such photocatalysts in the form in which they are kneaded into fiber or plastic. Also, when such photocatalysts are used as antibacterial or antimildew materials, the microbes do not readily adhere to the photocatalyst in running water, etc., so the effect thereof is diminished and efficiency is poor.

In view of this, the inventor developed a photocatalyst environmental material in which calcium phosphate is supported on the surface of a substrate having a surface composed of titanium oxide, by immersing this substrate in a simulated body fluid, in order to solve the above problems. ((7) Japanese Laid-Open Patent Application H10-244166). With this photocatalyst environmental material, the titanium oxide on the surface is partially covered by calcium phosphate, and the titanium oxide is also partially exposed, so any organic compounds contaminating the environment, such as organic solvents or agrochemical dissolved in water, or harmful substances in the air, or unpleasant odors, can be easily decomposed and eliminated by the redox action of the electrons and holes produced on the titanium oxide surface under irradiation with light. Since calcium phosphate is inactive as a photocatalyst, even when it is kneaded into a medium such as organic fiber or plastic, what comes into contact with the organic fiber, plastic, or other medium is inert calcium phosphate, so the organic fiber or plastic itself is protected by the calcium phosphate and tends not to decompose, allowing the effect to be sustained for an extended period. Further, because calcium phosphate has the property of adsorbing bacteria and the like, any adsorbed bacteria or the like can be effectively and efficiently killed and decomposed by the powerful oxidative force produced by the titanium oxide under irradiation with light.

However, a drawback to a method for manufacturing a photocatalyst environmental material by immersing a substrate having a surface composed of titanium oxide in a simulated body fluid was that preparing the simulated body fluid was not easy, so the manufacture took a long time (from a few days to a few weeks). Another drawback was that the simulated body fluid had to be heated and kept warm for a long time, which meant that energy consumption was high.

Other issues that have become more serious problems in recent years include odors in living and work spaces, and pollution by harmful substances such as automotive exhaust gases and volatile organic chemical substances. This has led to “sickhouse syndrome,” hypersensitivity to chemical substances, and so forth becoming serious problems.

One method commonly performed to remove harmful substances from the air or to prevent unpleasant odors is to absorb them into an absorbent liquid such as an acid or alkali or to adsorb them into an adsorbent, but a problem with this method is how to dispose of the waste liquid or used adsorbent, which can result in secondary pollution. Another method is to hide unpleasant odors by using a perfume, but a drawback is the possibility that the odor of the perfume will be transferred to a food, so that the food is damaged by the smell of the perfume itself (see, for example, (3) Konosuke Nishida, Heibonsha “Encyclopedia,” Vol. 1, p. 136 (1984)).

When irradiated with light, titania produces electrons with a powerful reductive action and holes with a powerful oxidative action, and decomposes any molecular species with which it comes into contact by a redox action. This action of titania, namely, its photocatalytic action, can be utilized to decompose and remove organic solvents, agrochemical, surfactants, and other such environmental pollutants dissolved in water, and harmful substances, unpleasant odors, and so forth in the air. This method has the advantages that it can be repeated over and over merely by utilizing titania and light, the reaction products are harmless carbon dioxide and so on, there are fewer restrictions on the reaction conditions, such as temperature, pH, gas atmosphere, and toxicity, than with such methods as biological treatment using microbes, and furthermore, even organic halogen compounds, organic phosphorus compounds, and other such compounds that are difficult to treat with methods such as biological treatment can be easily decomposed and removed.

However, titania was used directly in the form of a powder as a photocatalyst in research conducted up to now into the decomposition and removal of organic matter with a titania photocatalyst, which is a photocatalytic substance composed of titania (see, for example, (4) A. L. Pruden and D. F. Ollis, Journal of Catalysis, Vol. 82, 404 (1983), (5) H. Hidaka, H. Jou, K. Nohara, and J. Zhao, Chemosphere, Vol. 25 1589 (1992), and (6) Teruaki Hisanaga, Kenji Harada, and Keiichi Tanaka, Kogyo Yosui [Industrial-use Water], No. 379, 12 (1990)). As a result, such powders were difficult to handle and use, and were therefore difficult to put to practical use. In view of this, there have been attempts at coating a titania photocatalyst with activated carbon or another material that will serve as a carrier, but since the powerful photocatalytic action not only is exerted on harmful organic matter or environmental pollutants, but also decomposes the activated carbon carrier, repeated use or long-term use is impossible. A mixture of a titania photocatalyst and activated carbon has also been developed, but since the titania photocatalyst and the activated carbon are in close contact in this case, any substances to which this activated carbon is adsorbed cannot be decomposed by the titania photocatalyst, so the performance of such products is low.

### DISCLOSURE OF THE INVENTION

In light of the prior art described above, the inventor conducted diligent research aimed at finding a novel cleaning agent and cleaning method which are excellent in terms of both safety and ease of use, and also provide an outstanding cleaning effect, and as a result arrived at the present invention upon discovering that the desired objective could be achieved by combining at least one member of the group consisting of oxygen-defective titanium oxide TiOₓ (1.5<x<2), titanium oxynitride TiOₓN₂₋ₓ(1<x<2), diamond-like carbon, and a titania-silica complex TiOₓ—SiO₂ (1.5<x≦2), or a covered component produced by partially covering the surface of these with a ceramic, with a thickener and an oxidant as the active components.

Specifically, in a first aspect of the present invention, the object is to provide a novel cleaning method that is excellent in terms of safety and ease of use, has an outstanding cleaning effect, and involves utilizing sunlight or other such optical energy.

It is another object of the present invention to provide a novel cleaning agent used in the above-mentioned cleaning method.

A second aspect of the present invention was newly developed in light of the above, and it is an object thereof to provide a novel antibacterial material and an antibacterial product that makes use of this antibacterial material, that not only inhibit the proliferation of microbes upon irradiation with visible light as well as with ultraviolet rays, but also have a good antibacterial effect that allows these microbes to be decomposed, rendered harmless, and removed, and that can be used economically and safely, and furthermore that will not decompose the organic matter of the substrate and can therefore be used repeatedly, and are therefore also excellent in terms of durability, and can be used safely and with a small amount of energy over an extended period.

The inventor conducted diligent research aimed at achieving this object, and as a result arrived at the present invention upon discovering that when an antibacterial material is manufactured by partially covering the surface of a substrate composed of oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), or a metal ion-doped titanium oxide with a ceramic that is inert to light, this material will exhibit an efficient redox action under irradiation not only with ultraviolet rays but also visible light, allowing the proliferation of microbes to be efficiently inhibited or these microbes to be decomposed and removed, and furthermore, when a substrate is partially covered with a ceramic that is inert to light, the substrate will not be prone to decomposition and its effect can be sustained for an extended period of time, and upon discovering that an antibacterial product in which this antibacterial material is used will similarly have a substrate that is not prone to decomposition, and the antibacterial effect can be sustained for an extended period.

A third aspect of the present invention was newly developed in light of the above, and it is an object thereof to provide a method for the simple, quick, and low-energy manufacture of an environmental material that is capable of effectively, economically, and safely cleaning an environment, such as removing an unpleasant odor, decomposing and removing harmful substances or soils from the air, treating water, or providing an antibacterial or antimildew effect, and furthermore, when added such as by being kneaded into a medium such as organic fiber or plastic, provides excellent durability, with no degradation of the medium.

The inventor conducted diligent research aimed at achieving the above object, and as a result arrived at the present invention upon discovering that an environmental material in which calcium phosphate is supported on the surface of a substrate having a surface composed of titanium oxide can be manufactured quickly by using an aqueous solution containing calcium ions, phosphate ions, and/or hydrogenphosphate ions, without using a simulated body fluid, and immersing this substrate in this solution and irradiating it with microwaves.

A fourth aspect of the present invention was newly developed in light of the above, and it is an object thereof to provide a novel functional adsorbent that does not decompose the porous material of the substrate, is durable and can be used repeatedly, not only adsorbs unpleasant odors or harmful substances in the air, but also decomposes and removes them, and allows an environment to be cleaned effectively, economically, and safely, and a method for manufacturing this functional adsorbent.

The present invention will now be described in further detail.

To achieve the stated object, the first aspect of the present invention achieves a good cleaning effect with respect to soils by using a cleaning agent composed of specific components and utilizing a redox action provided mainly by a photocatalyst. The basic chemicals and means used in the present invention are at least one member of the group consisting of oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), or a covered component produced by partially covering the surface of these with a ceramic, and a thickener and an oxidant; light is all that is needed with this cleaning agent, it is very safe and easy to use, and its cleaning effect is outstanding.

In a preferred aspect, the cleaning agent of the present invention comprises at least one type of powder selected from the group consisting of oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), and a metal ion-doped titanium oxide, or a covered component produced by partially covering the surface of these with a ceramic, and a thickener and an oxidant. The above-mentioned ceramic refers, for example, to alumina, silica, zirconia, zirconium titanate, magnesia, calcia, calcium phosphate (apatite), titanium phosphate, iron oxide, ferrite, gypsum, amorphous titania, and compounds having the same effect as these. The oxygen-defective titanium oxide TiOₓ (1.5<x<2) is the product of partially reducing titanium dioxide, and titanium oxynitride TiOₓN₂₋ₓ (1<x<2) is prepared by a method in which titanium dioxide is partially nitrided with ammonia or the like, or a method in which titanium nitride is partially oxidized. The diamond-like carbon is prepared by a method such as CVD from methane or an alcohol and hydrogen, and the titania-silica complex TiOₓ—SiO₂ (1.5<x≦2) is prepared by a method in which titanium oxide is supported on a silica gel, or a method in which silica is supported on titanium oxide. There are no particular restrictions on these preparation methods in the present invention. The diamond-like carbon referred to in the present invention also encompasses that which has been doped with a metal ion or the like.

As can be seen from their constituent elements, these components are nontoxic and safe substances. Favorable examples of the form thereof include microparticles with a size of about 4 to 100 nm, and substances made up primarily of these microparticles, although other forms are also possible, such as thin flakes, and the form and properties thereof are not important. In this case, a smaller particle size is advantageous, for example, because activity will be higher, the amount made to adhere may be smaller so less need be used, and a transparent liquid or paste can be prepared. Furthermore, a smaller particle size is particularly favorable because a thin coating film can be formed and light can reach the middle of the solution or paste, affording a better cleaning effect. In terms of being safe and nontoxic, the thickener is preferably an inorganic layered compound such as smectite, bentonite, montmorillonite, aluminum magnesium silicate, hectorite, acidic China clay, or ordinary clay. Further examples of thickeners include phosphoric acid, pyrophosphoric acid, polyphosphoric acid, tripolyphosphoric acid, hexametaphosphoric acid, ultraphosphoric acid, acetic acid, citric acid, tartaric acid, malic acid, formic acid, gluconic acid, silicic acid, succinic acid, oxalic acid, sorbic acid, aluminic acid, hydrochloric acid, sulfuric acid, nitric acid, carbonic acid, lactic acid, folic acid, butyric acid, alginic acid, carboxylic acid, acrylic acid, polyacrylic acid, silicic acid, boric acid, and other such acids, as well as their sodium salts, potassium salts, aluminum salts, magnesium salts, ammonium salts, calcium salts, and other such salts, starch, casein, dextrin, gum arabic, molasses, methyl cellulose, hydroxyethyl cellulose, polyvinyl alcohol, polyethylene glycol, polyethylene oxide, vinyl acetate emulsion, isobutyl-maleic acid copolymer, epoxy resin, phenol resin, furan resin, urethane resin, coumarone resin, urea resin, and other such polymers, ultra-microparticles of metal oxides such as silica or alumina, ethyl silicate, zirconium acetate, aluminum isopropoxide, titanium isopropoxide, peroxotitanic acid, and other such organometals and metal complexes. These can be used singly or in combinations of two or more types. Favorable examples of the oxidant include oxygen, ozone, hydrogen peroxide, calcium peroxide, magnesium peroxide, sodium peroxide, calcium peroxide, and other such oxides. Hydrogen peroxide and other peroxides can be used safely at a low concentration of 5% or less.

The weight ratio of the above components can be varied and adjusted as needed depending on how severe the soiling is, and this allows the product to be tailored to the situation. Usually, the cleaning agent of the present invention can be used in the form of a uniform transparent solution or paste by blending at least one member of the group consisting of oxygen-defective titanium oxide TiOₓ (1.5<x<2), titanium oxynitride TiOₓN₂₋ₓ(1<x<2), diamond-like carbon, a titania-silica complex TiOₓ—SiO₂ (1.5<x≦2), or a covered component produced by partially covering the surface of these with a ceramic, and a thickener and an oxidant in water, and kneading and dispersing these components, but the scope of the present invention is not limited to these, and any similarly prepared product can be similarly used and is encompassed by this scope.

The phrase “solution or paste” in the present invention is defined as having the above meaning. In this case, there are no particular restrictions on the means and apparatus for preparing the cleaning agent, such as the blending, kneading, and dispersal of the above components, or on the means for causing the cleaning agent to adhere, and so forth, and any suitable means such as painting or spraying can be employed. Here, for example, the cleaning agent of the present invention may be used to impregnate cloth, paper, glass cloth, ceramic paper, an organic gel, an inorganic gel, or the like, then this product applied to the surface of the target object and irradiated with light. Other suitable methods and means can also be employed, such as a method in which the above-mentioned cleaning agent is supported on a suitable carrier, and this product is applied to the target object. The cleaning agent of the present invention is characterized in that the above-mentioned components are used together as the active components, but there are no particular restrictions on the form thereof, and these components can be blended together in the form of a solution or paste, or they can be prepared separately and then combined as needed.

The target object is cleaned with the above-mentioned cleaning agent, for example, by coating the surface of the target object with the cleaning agent and then irradiating it with light. The light used in the present invention may be either sunlight or artificial light from an electric lamp or the like. Artificial light sources include those commonly used for photocatalysts, such as sterilizing lamps, mercury vapor lamps, black lights, UV lamps, xenon lamps, and carbon arc lamps, as well as fluorescent lamps, incandescent lamps, halogen lamps, metal halide lamps, LEDs (light emitting diodes), semiconductor lasers, light emitted by CRTs, fluorescent paints, and phosphorescent materials, and any of various other types that were not used up to now because of their large proportion of visible light. From the standpoint of generating active oxygen by photocatalytic action and its oxidative action, the light used for irradiation preferably includes a large amount of light with a short wavelength and high energy, such as ultraviolet light, but ultraviolet light also causes inflammation and cancer in humans, so visible light is preferred from the standpoint of safety. How many times the cleaning agent of the present invention is applied and irradiated with light should be suitably adjusted according to the severity of soiling. How often the above-mentioned solution or paste is applied should also be suitably set according to the soiling condition. The cleaning method of the present invention is effective against both soiling by organic matter and adhered soil that contains organic matter as a binder, and exhibits an outstanding effect in terms of removing these safely and simply.

The primary action of the cleaning agent of the present invention is a photocatalytic action. When oxygen-defective titanium oxide TiOₓ (1.5<x<2), titanium oxynitride TiOₓN₂₋ₓ (1<x<2), diamond-like carbon, or a titania-silica complex TiOₓ—SiO₂ (1.5<x≦2) is irradiated with light, electrons and holes are produced, and these holes react with hydroxide ions and the like to produce active oxygen. This active oxygen has a much more powerful oxidative strength than ozone, and is capable of oxidatively decomposing nearly all organic matter into carbon dioxide, and this is how soil is decomposed and removed. As irradiation with light is continued, electrons accumulate, and these accumulated electrons bond with holes, which brings the oxidative decomposition reaction to a halt, but since the oxidant in the cleaning agent of the present invention reacts with and removes these electrons, the oxidative decomposition reaction can proceed efficiently on a continuous basis. Also, since the cleaning agent is transparent and an oxidant is added, active oxygen is readily produced at the interface between the cleaning agent and the target object, allowing any soil on the surface of the target object to be oxidatively decomposed very efficiently.

The thickener contained in the cleaning agent of the present invention allows the cleaning agent to be held for a longer time on the surface of a vertical target object, such as the wall of a building, and also allows the oxidant to be held in place for an extended period, so the cleaning agent of the present invention can continuously and efficiently promote an oxidative decomposition reaction. Further, oxygen-defective titanium oxide TiOₓ (1.5<x<2), titanium oxynitride TiOₓN₂₋ₓ (1<x<2), diamond-like carbon, and a titania-silica complex TiOₓ—SiO₂ (1.5<x≦2) readily produce active oxygen having a powerful oxidative strength when irradiated not only with ultraviolet rays but also visible light, so unlike titanium dioxide photocatalysts and that like that can only be used with ultraviolet rays having a wavelength of 380 nm or less, these materials utilize sunlight and lamp light very efficiently, which means that soils can be efficiently decomposed and removed without the use of dangerous ultraviolet light. No photocatalytic action is exhibited when x is 1.5 or less in the oxygen-defective titanium oxide TiOₓ (1.5<x<2) or titania-silica complex TiOₓ—SiO₂ (1.5<x≦2).

Next, the second aspect of the present invention is an antibacterial material wherein the surface of a substrate composed of oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), or a metal ion-doped titanium oxide is partially covered with a ceramic that is inert to light. The oxygen-defective titanium oxide TiOₓ (1.5<x<2) here is the product of partially reducing titanium oxide. The titanium oxynitride TiOₓN₂₋ₓ (1<x<2) is prepared, for example, by partially nitriding titanium oxide with ammonia or the like, or by partially oxidizing titanium nitride. The diamond-like carbon can be prepared by a method such as CVD from methane or an alcohol and hydrogen. The titania-silica complex TiOₓ—SiO₂ (1.5<x≦2) is prepared by supporting titanium oxide by a method such as impregnating a porous material containing SiO₂, such as a silica gel, with an organotitanium compound and then firing this product. These substances are all safe, and are preferably used in the form of microparticles with an average size of approximately 1 to 10 μm, and even more preferably 4 to 100 nm, or a material made up primarily of these microparticles, although other forms are also possible, such as thin flakes, and the form and properties thereof are not important. In this case, a smaller particle size is advantageous, for example, because activity will be higher, a smaller amount need be used, and a transparent solution, paste, or paint can be prepared. Furthermore, a smaller particle size is particularly favorable because light can reach the middle of the solution, paste, or paint, affording a better antibacterial effect.

From the standpoint of higher performance as a photocatalyst, the crystal form of the raw material titanium oxide is anatase or brookite. Rutile and amorphous materials are not really desirable because of their low activity as a photocatalyst. It is also preferable for at least one type of metal such as platinum, rhodium, ruthenium, palladium, silver, copper, zinc, and so forth to be supported on the surface of the antibacterial material of the present invention, which further raises the oxidative decomposition rate of chemical substances and affords greater photocatalytic action.

Examples of the ceramic that is inert to light include one or more types such as alumina, silica, zirconia, zirconium titanate, magnesia, calcia, calcium phosphate, titanium phosphate, iron oxide, ferrite, gypsum, and amorphous titania, but any materials having the same effect as these can similarly be used.

The partial covering of the surface of a substrate such as oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), or a metal ion-doped titanium oxide with a ceramic that is inert to light can be accomplished, for instance, by a method in which a metal alkoxide or an organometal is hydrolyzed on the surface of the substrate, and this product is baked to produce islands of optically inert ceramic on the substrate surface, a method in which an organic material is dissolved in a sol of a ceramic precursor, and the substrate surface is coated with this solution and baked to cover the surface with a ceramic film with holes in it, or a method in which the substrate is immersed in a solution containing the constituent components of a ceramic to produce islands of optically inert ceramic on the substrate surface, but there are no particular restrictions on the covering method in the present invention.

With the antibacterial material of the present invention obtained in this manner, the surface of a substrate such as oxygen-defective titanium oxide TiOₓ (1.5<x<2), titanium oxynitride TiOₓN₂₋ₓ (1<x<2), diamond-like carbon, a titania-silica complex TiOₓ—SiO₂ (1.5<x≦2), or a metal ion-doped titanium oxide is covered with islands of a ceramic that is inert to light, or the surface of titania particles is covered with a ceramic film that has holes in it and is inert as a photocatalyst, resulting in a state in which the substrate is partially covered and partially exposed. Accordingly, any microbes that come into contact with this product can be killed and quickly, continuously, and effectively decomposed and removed by the redox action of electrons and holes produced on the substrate by irradiation with a fluorescent lamp, incandescent lamp, black light, UV lamp, mercury vapor lamp, xenon lamp, halogen lamp, metal halide lamp, or other such artificial light or sunlight. Also, because it decomposes microbes merely by irradiation with light, the above-mentioned antibacterial material can be used repeatedly, and therefore affords extended use at lower cost and energy consumption and with no maintenance. Also, the ceramic that is inert to light and is composed of at least one of alumina, silica, zirconia, zirconium titanate, magnesia, calcia, calcium phosphate, titanium phosphate, iron oxide, ferrite, gypsum, and amorphous titania has an adsorptive action, and this action allows microbes to be adsorbed efficiently. In addition, if at least one type of metal such as platinum, rhodium, ruthenium, palladium, silver, copper, iron, or zinc is supported on the surface, the catalytic action of the metal will further enhance the antibacterial and antimildew effect.

The antibacterial liquid and antibacterial product pertaining to the present invention are manufactured by using the antibacterial material obtained as above, and dispersing it in water or the like, kneading it into another product, making it into a paint and applying it, dispersing it in water or a solvent and spraying it onto an object, or dip coating an object. Even if the substrate of the product is an organic material, since the portion in contact with the antibacterial material is a ceramic that is inert as a photocatalyst, the substrate tends not to be decomposed, allowing the antibacterial effect to be sustained for an extended period.

The antibacterial liquid pertaining to the present invention is produced by dispersing the above-mentioned antibacterial material in water or the like, and is used by coating the floors or walls of a kitchen, hospital, workplace, building, or the like, or by coating rugs or carpeting, the skin, or the like. This antibacterial liquid is capable of efficiently and safely killing germs, E. coli, and so forth, and can be utilized to prevent hospital infections, food poisoning, and so on.

Examples of the antibacterial product pertaining to the present invention include antibacterial bath products, antibacterial textile products, antibacterial artificial plants, antibacterial plastic products, antibacterial paper products, antibacterial paints, and antibacterial wood and bamboo products. Examples of other possible products include antifouling paints for ship hulls and fishing nets, water treatment packing agents, agricultural films, weed barrier sheets, packaging materials, and so forth.

The antibacterial bath product pertaining to the present invention is a bath product containing the above-mentioned antibacterial material, and is manufactured by dispersing microparticles of the antibacterial material, or by further adding an inorganic layered compound or other such thickener, perfume, etc. This product is added to and dispersed in bath water, which safely and efficiently kills any germs or Legionella in the bath water. It can also be added to products such as body shampoo.

The antibacterial textile product pertaining to the present invention is produced by supporting the antibacterial material of the present invention on a textile product by coating, kneading, or the like. Examples of textile products include woven, knitted, and nonwoven fabric made of natural fibers such as wool, silk, cotton, and flax, regenerated fibers such as rayon and acetate, synthetic fibers such as nylon, acrylic, polyamide, polyester, polyacrylonitrile, and polyvinyl chloride, or heat-resistant fibers such as aramid, all of which may be used either alone or as a blend; fabrics that have been treated with a silicon-based water repellant, a fluorine-based water repellant such as a perfluoroalkyl acrylate, a zirconium salt-based water repellant, or an ethylene-urea-based water repellant; fabrics that have also been waterproofed with a crosslinking agent based on ethyleneimine, epoxy, or melamine in order to improve durability; synthetic leather comprising a polyurethane resin layer formed via a polyurethane adhesive on a substrate such as artificial leather, woven fabric, nonwoven fabric, or a knit composed of fibrillated composite fibers of polyamide and polyester; and products such as umbrellas, tents, bags, curtains, wallpaper, and other such interior products, tents, tablecloths and other such sundries, food packaging materials, gardening sheets, bed sheets, towels, masks, wall cloth, curtains, tablecloths, sleepwear, men's suits, other suits, overcoats, and so forth. These products can be used for extended periods, with any germs, E. coli, or the like being safely and efficiently killed.

The antibacterial artificial plant pertaining to the present invention is produced by kneading the above-mentioned antibacterial material into artificial flowers, decorative plants, aquatic plants, seaweed, or the like, or coating these with the antibacterial material, which allows germs, E. coli, or the like to be safely and efficiently killed, and allows the product to be used for an extended period.

The antibacterial plastic product pertaining to the present invention is produced by supporting the antibacterial material of the present invention on a plastic product by coating, kneading, or the like. Examples of plastic materials include polyethylene, nylon, polyvinyl chloride, polyvinylidene chloride, polyester, polypropylene, polyethylene oxide, polyethylene glycol, polyethylene terephthalate, silicone resin, polyvinyl alcohol, vinylacetal resin, polyacetate, ABS resin, epoxy resin, vinyl acetate resin, cellulose, cellulose derivatives, polyamide, polyurethane, polycarbonate, polystyrene, urea resin, fluororesin, polyvinylidene fluoride, phenol resin, celluloid, chitin, starch sheets, polyacrylic ester, polymethyl methacrylate, polyamide, polyimide, polyvinylidene fluoride, and various other plastics, as well as fluoroethylene-propylene copolymer resin, fluoroethylene-ethylene copolymer resin, and copolymers of these. Examples of the antibacterial plastic product pertaining to the present invention include containers, vehicle bodies, lenses, eyeglass bows, bags, cables, hoses, office supplies, cases and parts for various electrical products such as television sets, refrigerators, washing machines, vacuum cleaners, fans, radios, cassette players, stereos, lighting lamps, and computers; furniture, building materials, credit cards and other such cards, heat-reflective films, UV-blocking films, tear-resistant films, computer monitor protective films, synthetic wood, and so forth, which allows germs, E. coli, or the like to be safely and efficiently killed, prevents slime and soil, and allows the product to be used for an extended period.

The antibacterial paper product pertaining to the present invention is produced by supporting the antibacterial material of the present invention on a paper product by coating, screening, or the like. Examples include wallpaper, lampshades, fusuma [Japanese sliding doors, shoji sliding paper doors, notebook paper, Japanese writing paper, pocket paper kept inside a kimono, and various other types of paper, which allows germs, E. coli, or the like to be safely and efficiently killed, prevents discoloration, and allows the product to be used for an extended period.

The antibacterial paint pertaining to the present invention is produced by mixing or dispersing the above-mentioned antibacterial material into a paint, ink, or coating liquid, which allows germs, E. coli, or the like to be safely and efficiently killed, prevents corrosion and soiling, and allows the product to be used for an extended period.

The antibacterial wood and bamboo product pertaining to the present invention is produced by supporting the above-mentioned antibacterial material on lumber, columns, buildings, baskets, buckets, ship hulls, building materials, and other such wood and bamboo products by coating, impregnation, or the like. Examples include construction materials for walls, ceilings, columns, and so forth, printed laminates, furniture, woodwork, interior materials, and decorative materials. This allows germs, E. coli, or the like to be safely and efficiently killed, prevents corrosion and soiling, and allows the product to be used for an extended period.

Next, in a third aspect of the present invention, the substrate having a surface composed of titanium oxide is either titanium oxide itself or contains titanium oxide on the surface, such as a material in which titanium oxide is supported on a substrate. Examples of the substrate used for this purpose include activated carbon, activated alumina, silica gel, zeolite, sintered clay, glass, ceramic, metal, and plastic, to name just a few, but in terms of transmitting light, silica gel and glass are particularly favorable. It is also preferable for the substrate to contain silicon or titanium, but may be composed solely of titanium oxide. The shape of the substrate used in the present invention may be granular, plate-like, cylindrical, prismatic, conical, spherical, gourd-shaped, rugby ball-shaped, or any other such shape. The substrate may also be of any size, but small particles of sub-micron size are preferable when kneading into organic fibers, plastic, or the like is taken into account.

The titanium oxide can be supported on the surface of the above-mentioned substrate by a variety of methods, such as vapor deposition, PVD, CVD, sputtering, coating with a titanium oxide sol by sol-gel method or the like, or the binding of titanium oxide ultrafines.

Favorable examples of the titanium oxide used in the present invention include not only titanium dioxide, but titanium oxide of non-stoichiometric titanium and oxygen, oxygen-defective titanium dioxide, titanium dioxide in which some of the oxygen has been nitrided, and titanium oxide doped with metal ions. In terms of high performance as a photocatalyst, the crystal form is preferably anatase. Rutile, brookite, and amorphous forms are undesirable because the activity of the photocatalyst will be lower. A metal such as platinum, rhodium, ruthenium, palladium, silver, copper, or zinc may be supported on the surface of the titanium oxide, which further raises the oxidative decomposition rate of chemical substances and affords greater bactericidal and mildewcidal action.

The aqueous solution used in the present invention for immersing the substrate whose surface is covered with titanium oxide is an aqueous solution containing calcium ions, phosphate ions, or hydrogenphosphate ions, and is prepared by dissolving a calcium salt such as calcium chloride, or a phosphate such as potassium phosphate, sodium phosphate, potassium hydrogenphosphate, or sodium hydrogenphosphate in water, but need not be a water-soluble salt, and can instead be a salt that does not readily dissolved in water, such as gypsum, or a waste product containing calcium or phosphorus, such as shells. When a substance containing calcium or phosphorus such as this is added to the aqueous solution, calcium or phosphorus is replenished in the aqueous solution, and the waste product is also effectively utilized. Also, the aqueous solution may contain cations or anions other than calcium ions, phosphate ions, or hydrogenphosphate ions.

The concentration of calcium ions in the aqueous solution used in the present invention is preferably 0.5 to 100 mM, and the concentration of phosphate ions and/or hydrogenphosphate ions is preferably 1 to 50 mM. If the concentration is higher than this, there is the possibility that the calcium phosphate that is produced will be low in strength and be brittle.

Microwaves readily raise the temperature of the aqueous solution in which the substrate is immersed, and the higher the temperature, the faster the calcium phosphate is produced. The pH of the solution in which the substrate is immersed is preferably from 6 to 9, and particularly from 7 to 7.5. Calcium phosphate will tend not to be produced if the pH is under 6 or over 9.

There are no restrictions on the frequency of the microwaves used in the present invention, which may be 30 GHz, 90 GHz, etc., but the 2.45 GHz frequency used in household microwave ranges as stipulated by the Radio Law is the most convenient to use. The duration of the microwave irradiation need only be from a few minutes to a few hours.

After the substrate has been immersed in an aqueous solution containing calcium ions, phosphate ions, or hydrogenphosphate ions and irradiated with microwaves, it is dried in an electric furnace, gas furnace, or the like at 40 to 600° C.

The phrase “environmental material” as used in the present invention is defined to mean an environmental cleaning material having an environmental cleaning function such as removing unpleasant odors, decomposing and removing harmful substances or contaminants in the air, treating wastewater, purifying water, or killing bacteria or mold in water.

When the above-mentioned environmental material is kneaded into a medium such as organic fibers or a plastic, since the portion in contact with the organic fibers, plastic, or the like is calcium phosphate that is inert as a photocatalyst, there is no decomposition of the organic fibers, plastic, or the like, the organic compounds contaminating an environment, such as unpleasant odors, harmful substances such as NOx in the air, organic solvents or agrochemical dissolved in water, and so forth, can be adsorbed and then quickly and continuously decomposed and removed by the redox action of the electrons and holes produced in the titanium oxide as a result of irradiation with sunlight or artificial light from a fluorescent lamp, incandescent lamp, black light, UV lamp, mercury vapor lamp, xenon lamp, halogen lamp, metal halide lamp, or the like.

The environmental material pertaining to the present invention can be added to polyethylene, nylon, polyvinyl chloride, polyvinylidene chloride, polyester, polypropylene, polyethylene oxide, polyethylene glycol, polyethylene terephthalate, silicone resin, polyvinyl alcohol, vinylacetal resin, polyacetate, ABS resin, epoxy resin, vinyl acetate resin, cellulose, cellulose derivatives, polyamide, polyurethane, polycarbonate, polystyrene, urea resin, fluororesin, polyvinylidene fluoride, phenol resin, celluloid, chitin, starch sheets, and other kinds of organic fibers, plastics, and copolymers of these.

With the method of the present invention, a substrate having a surface composed of titanium oxide is immersed in an aqueous solution containing calcium ions, phosphate ions, and/or hydrogenphosphate ions and then irradiated with microwaves, whereupon the heating action of the microwaves and the action of stirring or the like result in hydroxyapatite, apatite carbonate, fluoroapatite, or other such calcium phosphate being produced in roughly one-hundredth the time it used to take, which allows a high-performance environmental material to be manufactured quickly and with less energy consumption.

Examples of the environmental cleaning product of the present invention include textile products, plastic products, paper products, ceramic products, glass products, concrete products, leather products, paints, inks, wood and bamboo products, artificial flowers, artificial decorative plants, interior products, accessories, electrical products, sheet materials, and bags.

In the fourth aspect of the present invention, rather than using titania in which the titanium and oxygen are in a stoichiometric ratio as the titania particles, titania of non-stoichiometric titanium and oxygen, oxygen-defective titania, titania in which some of the oxygen has been nitrided, titania doped with metal ions, and so forth may instead be used favorably. In terms of high performance as a photocatalyst, the crystal form is preferably anatase or brookite, while rutile and amorphous forms are undesirable because the activity of the photocatalyst will be lower. A metal such as platinum, rhodium, ruthenium, palladium, silver, copper, or zinc is preferably supported on the surface of the titania, which further raises the oxidative decomposition rate of chemical substances and affords greater photocatalytic action.

Examples of the ceramic that is inert to light and used in the present invention include alumina, silica, zirconia, zirconium titanate, magnesia, calcia, calcium phosphate, titanium phosphate, iron oxide, ferrite, gypsum, and amorphous titania, as well as compounds having the same effect as these. The “ceramic that is inert to light” in the present invention is defined as encompassing types that have low activity and are substantially inert as a photocatalyst.

Favorable examples of the porous material used in the present invention include activated carbon, foamed plastic, molded glass fiber, molded synthetic fiber, molded FRP, molded plastic-inorganic composite, molded fiber, activated alumina, zeolite, porous glass, porous metal, porous ceramic, molded clay, and a molded inorganic layered compound, as well as compounds having the same effect as these. The above-mentioned porous glass, porous metal, porous ceramic, molded clay, molded inorganic layered compound, and so forth may be molded using an organic binder.

The functional adsorbent of the present invention is manufactured by a method in which the surface of titania particles is partially covered with a ceramic that is inert to light, the resulting covered titania particles are dispersed in a solvent, and this dispersion is then used to impregnate a porous material, or by a method in which a porous material is coated with the above-mentioned covered titania particles by spraying the particles onto the porous material, for example, and then drying this coating.

The phrase “partially covered” as used here means that the surface of the titania particles is covered with islands of the ceramic that is inert to light, or that the surface of the titania particles is completely covered with a ceramic film that has holes in it and is inert to light, so that the titania is not completely covered by the ceramic film that is inert to light, and is instead partially exposed.

The functional adsorbent of the present invention obtained in this manner has covered titania particles supported on a porous material; for example, the surface of the titania particles is covered with islands of the ceramic that is inert to light, or the surface of the titania particles is covered with a ceramic film that has holes in it and is inert to light, so that the titania is only partially covered, the carrier and the substance are separated, and the titania is partially exposed. Accordingly, any organic compounds contaminating an environment, such as unpleasant odors, harmful substances such as NOx in the air, organic solvents or agrochemical dissolved in water, and so forth that have been adsorbed in the porous material that serves as the carrier are quickly and continuously decomposed and removed by the redox action of the electrons and holes produced in the titania as a result of irradiation with sunlight or artificial light from a fluorescent lamp, incandescent lamp, black light, UV lamp, mercury vapor lamp, xenon lamp, halogen lamp, metal halide lamp, or the like, and antibacterial and antimildew are similarly decomposed and removed. When activated carbon is used as the porous material, the resulting functional adsorbent will be bright blue in color, and can be used as a functional adsorbent with excellent adsorptivity, photocatalytic activity, and decorativeness. The present invention encompasses a functional adsorbent composed of this blue activated carbon.

Examples of the environmental cleaning product of the present invention include textile products, plastic products, paper products, ceramic products, glass products, concrete products, leather products, paints, inks, wood and bamboo products, artificial flowers, artificial decorative plants, interior products, accessories, electrical products, sheet materials, and bags.

In the case of an ordinary adsorbent, once adsorption of a substance reaches saturation, no further adsorption is possible, but the functional adsorbent pertaining to the present invention decomposes adsorbed substances merely by being irradiated with light, which allows it to be used repeatedly, the advantages of which are that the cost is lower, less energy is needed, and the adsorbent can be used for an extended period without any maintenance. The above-mentioned adsorbent can efficiently adsorb organic compounds contaminating an environment by the redox action of a ceramic that is inert to light, such as alumina, silica, zirconia, zirconium titanate, magnesia, calcia, calcium phosphate, titanium phosphate, iron oxide, ferrite, gypsum, or amorphous titania. Further, if a metal such as platinum, rhodium, ruthenium, palladium, silver, copper, iron, or zinc is supported on the surface of the titania particles, the catalytic action of this metal will further enhance the environmental cleaning effect, such as the decomposition and removal of organic compounds, or an antibacterial or antimildew effect. In addition, even if the porous material is an organic material, since the portion in contact with this organic material is a ceramic that is inert to light, the porous material is resistant to decomposition and the effect can be sustained for an extended period of time.

### BEST MODE FOR CARRYING OUT THE INVENTION

Examples of the first aspect of the present invention will now be given.

### EXAMPLE 1

0.8 g of diamond-like carbon with a particle size of 20 nm and 1 g of montmorillonite were added to 100 mL of 5% aqueous hydrogen peroxide, and the components were kneaded and dispersed to prepare a solution. This was sprayed onto the surface of a brick that had been soiled by spraying it with automotive exhaust gas, and then exposed to sunlight for 2 days. As a result, the black soil decomposed until the brick was clean. When no montmorillonite (thickener) was used, the solution soaked too far into the brick, preventing the brick from being properly cleaned. Also, no cleaning effect was observed when no hydrogen peroxide (oxidant) was used.

### EXAMPLE 2

0.5 g of titanium oxynitride with a particle size of 40nm, 0.2 g of bentonite, and 1 g of potassium peroxide were added to 50 mL of water, and the components were kneaded and dispersed to prepare a paste. This was applied to bathroom tile soiled with mildew, and then left overnight under light from a fluorescent lamp. This procedure was repeated 3 times, and as a result, the mildew was decomposed until the tile was clean. When no bentonite (thickener) was used, the paste ran down the tile, preventing the tile from being properly cleaned. Also, no cleaning effect was observed when no potassium peroxide (oxidant) was used.

### EXAMPLE 3

0.2 g of a titania-silica complex with a particle size of 800nm and 0.2 g of smectite were added to 10 mL of ozone water, and the components were kneaded and dispersed to prepare a paste. This was applied to soiled dentures, and then exposed to light from a 100 W incandescent lamp. As a result, the soiling was decomposed until the dentures were clean, and the unpleasant odor disappeared. When no smectite (thickener) was used, the paste ran down, preventing the dentures from being properly cleaned. Also, no cleaning effect was observed when no ozone water (oxidant) was used.

### EXAMPLE 4

(1) 0.5 g of oxygen-defective titanium oxide with a particle size of 30 nm and 0.5 g of aluminum magnesium silicate were added to 100 mL of water in which oxygen had been thoroughly dissolved, and the components were kneaded and dispersed to prepare a solution. This was applied to a yellowed tooth surface from which plaque, tartar, tar, and so forth had been removed with an ultrasonic scaler, and then irradiated with focused visible light for 60 minutes. Every 15 minutes fresh solution was applied and irradiated with light as above, and this procedure was repeated 4 times. As a result, the yellowing was decomposed until the tooth was pure white. When no aluminum magnesium silicate (thickener) was used, the solution ran down, preventing the tooth from being properly cleaned. Also, no cleaning effect was observed when oxygen (oxidant) had not been thoroughly dissolved in the water.

(2) 0.1 g of sodium phosphate and 50 mL of 3% aqueous hydrogen peroxide were added to 0.2 g of particles with a diameter of 30 nm and which had been produced by partially covering the surface of oxygen-defective titanium oxide with apatite, and the components were kneaded and dispersed to prepare a solution. This was sprayed onto white tile that had turned brown after being sprayed with cigarette smoke, then exposed to sunlight for 1 day, and the change in the yellow index (which is an index of whiteness) was measured. As a result, the yellow index that had been 16 was reduced to 6, meaning that the white tile had returned to its original whiteness.

(3) 0.1 g of pyrophosphoric acid, 0.05 g of polyvinyl alcohol, and 100 mL of 4% aqueous hydrogen peroxide were added to 0.5 g of particles with a diameter of 50 nm and which had been produced by partially covering the surface of titanium oxynitride with silica, and the components were kneaded and dispersed to prepare a solution. This was applied to sanitary earthenware that had turned brown after being sprayed with cigarette smoke, then exposed to sunlight for 1 day, and the change in the yellow index (which is an index of whiteness) was measured. As a result, the yellow index that had been 18 was reduced to 7, meaning that the material had returned to its original whiteness.

Examples of the second aspect of the present invention will now be given.

### EXAMPLE 5

(1) Preparation of Antibacterial Material

1) Titanium oxide microparticles with a size of approximately 50 nm were subjected to a plasma treatment under a vacuum and thereby reduced, which produced oxygen-defective titanium oxide. A small amount of water vapor was introduced into the surface thereof, and tetraethoxysilane gas was brought into contact with this surface to bring about hydrolysis, after which this product was dried to prepare an antibacterial material in which the surface of oxygen-defective titanium oxide was partially covered with islands of silica microparticles.

2) Titanium oxide microparticles with a size of approximately 30 nm were subjected to a plasma treatment under an ammonium atmosphere and thereby partially nitrided, after which a small amount of water vapor was introduced into the surface thereof, and aluminum triisopropoxide gas was brought into contact with this surface to bring about hydrolysis, after which this product was dried to prepare an antibacterial material in which the surface of titanium oxynitride was partially covered with islands of alumina microparticles.

3) Flakes of diamond-like carbon with a diameter of approximately 100 nm were produced by CVD using methanol and hydrogen gas. A small amount of water vapor was introduced into the surface thereof, and zirconium tetra-n-butoxide gas was brought into contact with this surface to bring about hydrolysis, after which this product was dried to prepare an antibacterial material in which the surface of diamond-like carbon was partially covered with islands of zirconia microparticles.

4) Chromium ion-doped titanium oxide microparticles were produced by ion injection into titanium oxide microparticles with a size of approximately 20 nm. 0.1 mol of titanium tetraisopropoxide was diluted with 200 mL of anhydrous ethanol, 0.1 mol of diethanolamine and 0.1 mol of water were added under stirring, and 5 g of polyethylene glycol with a molecular weight of 3000 was added to prepare a transparent sol. A small amount of this sol was collected, the chromium ion-doped titanium oxide microparticles produced above were added and the sol was then dried at 300° C., which resulted in the surface of the chromium ion-doped titanium oxide microparticles being covered with an amorphous titanium oxide film having holes in it.

5) Silica gel particles with a size of approximately 10 μm were impregnated with titanium tetraethoxide, then baked at 600° C. to produce a titania-silica complex. This was immersed in a solution containing 2.5 mM Ca²⁺ and 2.0 mM HPO₄²⁻ and left overnight at 80° C., which produced an antibacterial material in which the surface of a titania-silica complex was partially covered with islands of hydroxyapatite.

(2) Method for Evaluating Antibacterial Performance

A transparent sheet of polyester measuring 10 cm square was coated with the sample so that the film thickness (after drying) would be 1 μm, and this product was dried at 100° C. to sterilize it. An E. coli broth that had been cultured and diluted ahead of time and adjusted to a bacteria count of 50⁵/mL was dropped onto 0.2 mL of the sample, and the sample was then covered with a transparent film and placed in an incubator. Four samples that were irradiated with light from a fluorescent lamp (15 W, 2 tubes, 10 cm away from the light source) and four samples that had undergone no optical irradiation at all were placed in the incubator. 2 hours later the bacteria on the sample were rinsed off with sterile physiological saline and planted in an agar petri dish with a diameter of 95 mm, and the number of E. coli colonies was counted after 24 hours of culture at 36° C. Samples that had undergone exactly the same procedure up to the dropping of the E. coli broth and being placed in the incubator were treated by the same method, the number of E. coli colonies was counted, and this count was used as a reference to calculate the survival rate after a specific amount of time on each sample in the dark and under a fluorescent lamp.

(3) Accelerated Weather Test with Sunshine Carbon Arc Weatherometer

An accelerated weather test was conducted with a sunshine carbon arc weatherometer as set forth in JIS K 5400, using a model WEL-SUN-HCH made by Suga Test Instruments, for a test duration of 500 hours, a black panel temperature of 63° C., a 120-minute cycle, and 18 minutes of rain. Three samples were subjected to this accelerated weather test, after which each was evaluated by visually comparing the swelling, splitting, peeling, whitening, and surface change with that of an original sample that had not undergone the accelerated weather test.

Each of the antibacterial materials in 1) to 5) above was subjected to an antibacterial performance evaluation under optical irradiation, and as a result the bacteria count dropped to 10 or less in every case. Furthermore, no swelling, splitting, peeling, or and change in the surface such as whitening was observed as a result of conducting the accelerated weather test with the sunshine carbon arc weatherometer. In contrast, when the same test was conducted using the commercially available product (titanium oxide P-25) most commonly used as a standard sample for a photocatalyst, the bacteria count indicated 54% survival, and swelling, splitting, peeling, and whitening were noted.

### EXAMPLE 6

The antibacterial liquid pertaining to the present invention was prepared by dispersing the above-mentioned antibacterial material in distilled water or the like. This liquid was evaluated by antibacterial performance test, which revealed excellent antibacterial properties. Also, no degradation was seen in any sample when rugs or carpets were coated with the liquid and subjected to an accelerated weather test.

### EXAMPLE 7

The antibacterial bath product pertaining to the present invention was prepared by dispersing microparticles of the above-mentioned antibacterial material in water, and adding an inorganic layered compound. This product was evaluated by antibacterial performance test, which revealed excellent antibacterial properties.

### EXAMPLE 8

Antibacterial textile products pertaining to the present invention were produced by kneading the above-mentioned antibacterial material into yarn, fibers, woven fabric, nonwoven fabric, knitted fabric, synthetic leather, umbrellas, tents, bags, curtains, wallpaper and other such interior products, tents, suits, towels, masks, wall cloth, curtains, tablecloths and other such sundries, food packaging materials, gardening sheets,-over-sheets, towels, masks, wall cloth, sleepwear, men's suits, other suits, overcoats, and other apparel, and so forth. These products were evaluated by antibacterial performance test, which revealed excellent antibacterial properties. Also, no degradation was seen in any test piece subjected to an accelerated weather test. Test pieces produced by coating performed similarly.

### EXAMPLE 9

Antibacterial artificial plants pertaining to the present invention were produced by kneading the above-mentioned antibacterial material into artificial flowers, decorative plants, aquatic plants, seaweed, and the like. These products were evaluated by antibacterial performance test, which revealed excellent antibacterial properties. Also, no degradation was seen in any test piece subjected to an accelerated weather test. Test pieces produced by coating performed similarly.

### EXAMPLE 10

Antibacterial plastic products pertaining to the present invention were produced by kneading the above-mentioned antibacterial material into plastic containers, vehicle and other such bodies, lenses, eyeglass bows, bags, cables, hoses, office supplies, cases and parts for various electrical products such as television sets, refrigerators, washing machines, vacuum cleaners, fans, radios, cassette players, stereos, lighting lamps, and computers; furniture, building materials, credit cards and other such cards, heat-reflective films, UV-blocking films, tear-resistant films, computer monitor protective films, synthetic wood, and so forth. These products were evaluated by antibacterial performance test, which revealed excellent antibacterial properties. Also, no degradation was seen in any test piece subjected to an accelerated weather test. Test pieces produced by coating performed similarly.

### EXAMPLE 11

Antibacterial paper products pertaining to the present invention were produced by screening the above-mentioned antibacterial material onto wallpaper, lampshades, fusuma, shoji, notebook paper, Japanese writing paper, pocket paper, and various other types of paper. These products were evaluated by antibacterial performance test, which revealed excellent antibacterial properties. Also, no degradation was seen in any test piece subjected to an accelerated weather test. Test pieces produced by coating performed similarly.

### EXAMPLE 12

Antibacterial paints pertaining to the present invention were produced by mixing or dispersing the above-mentioned antibacterial material into a paint, ink, or coating liquid. These products were evaluated by antibacterial performance test, which revealed excellent antibacterial properties. Also, no degradation was seen in any test piece subjected to an accelerated weather test.

### EXAMPLE 13

Antibacterial wood and bamboo products pertaining to the present invention were produced by working the antibacterial material of the present invention into walls, ceilings, columns, and other such construction members, printed laminates, furniture, woodwork, interior materials, and decorative materials. These products were evaluated by antibacterial performance test, which revealed excellent antibacterial properties. Also, no degradation was seen in any test piece subjected to an accelerated weather test. Test pieces produced by coating performed similarly.

Examples of the third aspect of the present invention will now be given.

### EXAMPLE 14

Water and nitric acid were added to titanium tetraisopropoxide to prepare a transparent titanium oxide sol. This was used to coat alumina particles (the support) with a size of approximately 1 cm by dip coating, and then baked at 550° C. The coating and baking were repeated three times to obtain a substrate whose surface was covered with a titanium oxide film. Meanwhile, K₂HPO₄.3H₂O and CaCl₂ were dissolved in distilled water, and the pH was adjusted with hydrochloric acid, sulfuric acid, sodium hydroxide, and potassium hydroxide to prepare an aqueous solution with a pH of 7.1 containing 2.5 mM Ca²⁺ and 2.0 mM HPO₄²⁻. The above-mentioned substrate was placed in this solution to prepare an environmental material. The environmental materials thus obtained were observed under an analytical electron microscope, which revealed the surface thereof to be covered with islands of hydroxyapatite. When there was no microwave irradiation, it took 10 days to prepare the environmental material. 20 pieces of this environmental cleaning material were placed in flower vases along with water and left for 2 months under a fluorescent lamp, but no slime grew on the surface of the material, nor were there any bacteria or mold. In contrast, mold grew into slime in just 1 day when the above-mentioned environmental cleaning material was not put in.

### EXAMPLE 15

Titanium dioxide microparticles with a size of 30 nm were irradiated with plasma to prepare titanium oxide particles with oxygen defects. Meanwhile, K₂HPO₄.3H₂O and CaCl₂ were dissolved in distilled water, and the pH was adjusted with sodium hydrogencarbonate, potassium hydroxide, sulfuric acid, and hydrofluoric acid to prepare a 200 mL aqueous solution with a pH of 7.3 containing 10.0 mM Ca²⁺ and 6.0 mM F⁻, 4.2 mM HCO₃⁻, and 4.0 mM HPO₄²⁻. 5 g of the above-mentioned titanium oxide was placed in this solution and dispersed well, then irradiated for 30 minutes with 2.45 GHz microwaves at an output of 500 W to prepare an environmental material. The environmental materials thus obtained were analyzed with a powder X-ray analyzer, which revealed the production of hydroxyapatite, apatite carbonate, and fluoroapatite. The above-mentioned environmental cleaning material was kneaded into polyester, which was spun into fibers and evaluated for deodorizing effect. Specifically, a swatch of polyester measuring 10 cm square and woven from the above fibers was placed in a sealed vessel with a volume of 36 liters, 100 ppm acetaldehyde (used as a malodorous substance) was introduced by syringe, and this swatch was irradiated with light from a 300 W xenon lamp that closely resembled the wavelength distribution of sunlight. 6 hours later the concentration of acetaldehyde contained in the sealed vessel was examined by gas chromatography, which revealed that the acetaldehyde concentration had been lowered to 1 ppm, and the deodorizing effect was the same as when titanium oxide whose surface was not covered with apatite had been kneaded in directly. This experiment was repeated in order to examine durability, whereupon the polyester sheet degraded right away when titanium oxide was kneaded in directly, whereas the life of the polyester sheet was 20 times longer when the above-mentioned environmental cleaning material was used.

### EXAMPLE 16

A partially nitrided titanium oxide film was prepared on a substrate of Pyrex glass (registered trademark) by sputtering a target of titanium in air containing ammonia. Meanwhile, K₂HPO₄.3H₂O and CaCl₂ were dissolved in distilled water, and the pH was adjusted with sodium hydrogencarbonate, potassium hydroxide, sulfuric acid, and hydrofluoric acid to prepare an aqueous solution with a pH of 7.4 containing 50.0 mM Ca²⁺, 25.0 mM HCO₃⁻, and 250 mM HPO₄²⁻. The above-mentioned substrate was placed in this solution and irradiated for 40 minutes with 2.45 GHz microwaves at an output of 500 W to prepare an environmental material. The environmental materials thus obtained were observed under an analytical electron microscope, which revealed the surface thereof to be covered with a mixture of hydroxyapatite and apatite carbonate. The antibacterial and antimildew effects of these environmental cleaning materials were examined as follows. First, 1 mL of E. coli broth (bacteria count of 50⁵/mL) cultivated in a bouillon culture was dropped onto the environmental cleaning material, a transparent film was placed over this, and stationary culture was performed for 6 hours at 37° C. under a 20 W fluorescent lamp. A phosphate buffer was added and the liquid was shaken, after which 1 mL was taken out and the surviving bacteria count was measured by pour culture method. As a result, the sterilization rate was found to be over 99.9%.

### EXAMPLE 17

K₂HPO₄·3H₂O and CaCl₂ were dissolved in distilled water, and the pH was adjusted with sodium hydroxide, potassium hydroxide, sulfuric acid, and hydrofluoric acid to prepare a 500 mL aqueous solution with a pH of 7.2 containing 80.0 mM Ca^{2 +}, 30.0 mM F⁻, and 50.0 mM HPO₄²⁻. 5 g of chromium ion-doped titanium oxide with a particle size of 50 nm was put into this solution and dispersed well, then irradiated for 40 minutes with 2.45 GHz microwaves at an output of 500 W to prepare an environmental material. The environmental materials thus obtained were analyzed with a powder X-ray analyzer, which revealed the production of hydroxyapatite and fluoroapatite. The environmental cleaning materials were used to decolor a waste dye solution. Specifically, a 3 mL aqueous solution of 200 ppm methyl orange (used as a model waste solution) was placed in a quartz cell, after which 2 g of the above-mentioned environmental cleaning material was added, the system was irradiated with a 500 W extra-high pressure mercury vapor lamp, and the UV-visible absorption spectrum was measured. As a result, after 45 minutes the color had been completely removed, and the product was colorless and transparent.

Examples of the fourth aspect of the present invention will now be given.

### EXAMPLE 18

0.02 mol of tetraethoxysilane was diluted with 200 mL of anhydrous ethanol, after which 0.2 mol of water and 0.4 g of polyethylene glycol with a molecular weight of 100,000 were added under stirring, and then 0.004 mol of nitric acid was added to prepare a transparent sol. To this were added 20 g of anatase titania particles with a size of approximately 1 μm, and these were dispersed ultrasonically and then spray dried, after which the particles were baked at 500° C. The surface of the particles thus obtained was observed under an analytical electron microscope, which revealed the surface to be covered with silica having pores about 100 nm in size. The covered titania particles thus obtained were dispersed in water, after which activated carbon particles were added and stirred well, and the system was then dried. The functional adsorbent thus obtained was examined as follows for its deodorizing effect.

Specifically, 5 g of the above-mentioned functional adsorbent was put in a sealed vessel with a volume of 36 liters, and acetaldehyde (used as a malodorous substance) was introduced by syringe and adsorbed to saturation, after which the concentration of acetaldehyde contained in the sealed vessel was adjusted to 100 ppm, and the contents were irradiated with black light having an intensity of 1 mW/cm². 20 hours later the concentration of acetaldehyde contained in the sealed vessel was examined by gas chromatography, which revealed that the acetaldehyde concentration had been lowered to 10 ppm. This value indicates that the deodorizing effect was the same as when anatase titania particles whose surface was not covered with silica were used directly to produce an adsorbent.

An accelerated degradation test was conducted using a carbon arc lamp in order to examine durability, which revealed that when the adsorbent was produced using just titania particles not covered with a ceramic inert to light, the adsorbent gradually crumbled to a powder, whereas when the functional adsorbent of this example was used, almost no change was seen, nor was any decrease in performance noted.

### EXAMPLE 19

0.12 mol of aluminum triisopropoxide was diluted with 200 mL of isopropanol, after which 0.12 mol of triethanolamine and 1 mol of water were added under stirring, and then 2.5 g of polyethylene glycol with a molecular weight of 1000 was added to prepare a transparent sol. To this were added 5 g of 70% anatase and 30% rutile titania particles with a size of approximately 40 nm, and these were dispersed ultrasonically and then spray dried, after which the particles were baked at 450° C. The surface of the particles thus obtained was observed under an analytical electron microscope, which revealed the surface to be covered with alumina having pores about 100 nm in size. The covered titania particles thus obtained were dispersed in water, after which this dispersion was allowed to seep into molded polyester fibers, and this product was then dried. The functional adsorbent thus obtained was examined as follows for its deodorizing effect.

Specifically, 5 g of the above-mentioned functional adsorbent was put in a sealed vessel with a volume of 36 liters, and isovaleric acid (used as a malodorous substance) was introduced by syringe and adsorbed to saturation, after which the concentration of isovaleric acid contained in the sealed vessel was adjusted to 50 ppm, and the contents were irradiated with black light having an intensity of 1 mW/cm². 20 hours later the concentration of isovaleric acid contained in the sealed vessel was examined by gas chromatography, which revealed that the isovaleric acid concentration had been lowered to 5 ppm, and the deodorizing effect was the same as when titania particles whose surface was not covered with alumina had been used directly to produce an adsorbent.

An accelerated degradation test was conducted using a carbon arc lamp in order to examine durability, which revealed that when the adsorbent was produced using just titania particles not covered with a ceramic inert to light, the adsorbent gradually crumbled to a powder, whereas when the functional adsorbent of this example was used, almost no change was seen, nor was any decrease in performance noted.

### EXAMPLE 20

0.2 mol of zirconium tetra-n-butoxide was diluted with 500 mL of anhydrous ethanol, after which 0.4 mol of diethylene glycol and 0.4 mol of water were added under stirring, and then 0.4 g of polyethylene glycol with a molecular weight of 13,000 was added to prepare a transparent sol. To this were added 5 g of anatase titania particles with a size of approximately 800 nm and supporting platinum, and these were dispersed ultrasonically and then spray dried, after which the particles were baked at 500° C. The particles thus obtained were dispersed in water, after which this dispersion was allowed to seep into molded polyethylene terephthalate fibers, and this product was then dried.

The covered titania particles thus obtained were observed under an analytical electron microscope, which revealed the surface thereof to be covered with a zirconia film having pores about 50 nm in size. The covered titania particles thus obtained were dispersed in water, after which foamed plastic was added and stirred well, and the system was then dried. The functional adsorbent thus obtained was examined as follows for its deodorizing effect.

Specifically, 5 g of the above-mentioned functional adsorbent was put in a sealed vessel with a volume of 36 liters, and acetic acid (used as a malodorous substance) was introduced by syringe and adsorbed to saturation, after which the concentration of acetic acid contained in the sealed vessel was adjusted to 25 ppm, and the contents were irradiated with black light having an intensity of 1 mW/cm². 20 hours later the concentration of acetic acid contained in the sealed vessel was examined by gas chromatography, which revealed that the acetic acid concentration had been lowered to 2.5 ppm, and the deodorizing effect was the same as when anatase titania particles whose surface was not covered with zirconia had been used directly to produce an adsorbent.

An accelerated degradation test was conducted using a carbon arc lamp in order to examine durability, which revealed that when the adsorbent was produced using just anatase titania particles not covered with a ceramic inert to light, the adsorbent gradually crumbled to a powder, whereas when the functional adsorbent of this example was used, almost no change was seen, nor was any decrease in performance noted.

### EXAMPLE 21

0.1 mol of titanium tetraiisopropoxide was diluted with 200 mL of anhydrous ethanol, after which 0.1 mol of diethanolamine and 0.1 mol of water were added under stirring, and then 5 g of polyethylene glycol with a molecular weight of 20,000 was added to prepare a transparent sol. To this were added 5 g of anatase titania particles with a size of approximately 500 nm, and these were dispersed ultrasonically and then spray dried, after which the particles were baked at 350° C. The surface of the particles thus obtained was observed under an analytical electron microscope, which revealed the surface to be covered with amorphous titania having pores about 120 nm in size. The covered titania particles thus obtained were dispersed in water, after which this dispersion was sprayed onto molded clay and dried. The functional adsorbent thus obtained was examined as follows for its deodorizing effect.

Specifically, 5 g of the above-mentioned functional adsorbent was put in a sealed vessel with a volume of 36 liters, and methylmercaptan (used as a malodorous substance) was introduced by syringe and adsorbed to saturation, after which the concentration of methylmercaptan contained in the sealed vessel was adjusted to 25 ppm, and the contents were irradiated with black light having an intensity of 1 mW/cm². 20 hours later the concentration of methylmercaptan contained in the sealed vessel was examined by gas chromatography, which revealed that the methylmercaptan concentration had been lowered to 2.5 ppm, and the deodorizing effect was the same as when anatase titania particles whose surface was not covered with amorphous titania had been used directly to produce an adsorbent.

An accelerated degradation test was conducted using a carbon arc lamp in order to examine durability, which revealed that when the adsorbent was produced using just anatase titanium oxide not covered with a ceramic inert to light, the adsorbent gradually crumbled to a powder, whereas when the functional adsorbent of this example was used, almost no change was seen, nor was any decrease in performance noted.

### EXAMPLE 22

0.1 mol of titanium tetraiisopropoxide and 0.1 mol of zirconium tetra-n-butoxide were added to 500 mL of isopropanol, after which 0.4 mol of diisopropanolamine and 0.4 mol of water were added under stirring, and then 4 g of polyethylene glycol with a molecular weight of 3000 was added to prepare a transparent sol. To this were added 5 g of anatase titania particles with a size of approximately 700 nm and supporting silver, and these were dispersed ultrasonically and then spray dried, after which the particles were baked at 500° C. The particles thus obtained were observed under an analytical electron microscope, which revealed the surface to be covered with zirconium titanate having pores about 30 nm in size. The covered titania particles thus obtained were dispersed in water, after which this dispersion was sprayed onto a molded inorganic layered compound and dried. The functional adsorbent thus obtained was examined as follows for its deodorizing effect.

Specifically, 5 g of the above-mentioned functional adsorbent was put in a sealed vessel with a volume of 36 liters, and hydrogen sulfide (used as a malodorous substance) was introduced by syringe and adsorbed to saturation, after which the concentration of hydrogen sulfide contained in the sealed vessel was adjusted to 60 ppm, and the contents were irradiated with black light having an intensity of 1 mW/cm². 20 hours later the concentration of hydrogen sulfide contained in the sealed vessel was examined by gas chromatography, which revealed that the hydrogen sulfide concentration had been lowered to 5 ppm, and the deodorizing effect was the same as when anatase titania particles whose surface was not covered with zirconium titanate had been used directly to produce an adsorbent.

An accelerated degradation test was conducted using a carbon arc lamp in order to examine durability, which revealed that when the adsorbent was produced using just anatase titanium oxide not covered with a ceramic inert to light, the adsorbent gradually crumbled to a powder, whereas when the functional adsorbent of this example was used, almost no change was seen, nor was any decrease in performance noted.

### EXAMPLE 23

0.15 mol of magnesium ethoxide was diluted with 250 mL of anhydrous ethanol, after which 0.2 mol of N-ethyldiethanolamine and 0.6 g of water were added under stirring, and then 1.6 g of polyethylene glycol with a molecular weight of 1500 was added to prepare a transparent sol. To this were added 5 g of anatase titania particles with a size of approximately 500 nm, and these were dispersed ultrasonically and then spray dried, after which the particles were baked at 450° C. The particles thus obtained were observed under an analytical electron microscope, which revealed the surface to be covered with magnesia having pores about 20 nm in size. The covered titania particles thus obtained were dispersed in water, after which this dispersion was used to coat porous glass and dried. The functional adsorbent thus obtained was examined as follows for its deodorizing effect.

Specifically, 5 g of the above-mentioned functional adsorbent was put in a sealed vessel with a volume of 36 liters, and NOx (used as a harmful substance) was introduced by syringe and adsorbed to saturation, after which the concentration of NOx contained in the sealed vessel was adjusted to 10 ppm, and the contents were irradiated with black light having an intensity of 1 mW/cm². 20 hours later the concentration of NOx contained in the sealed vessel was examined by gas chromatography, which revealed that the NOx concentration had been lowered to 0.5 ppm, and the deodorizing effect was the same as when anatase titania particles whose surface was not covered with magnesia were used directly to produce an adsorbent.

An accelerated degradation test was conducted using a carbon arc lamp in order to examine durability, which revealed that when the adsorbent was produced using just anatase titanium oxide not covered with a ceramic inert to light, the adsorbent gradually crumbled to a powder, whereas when the functional adsorbent of this example was used, almost no change was seen, nor was any decrease in performance noted.

### EXAMPLE 24

0.2 mol of calcium methoxide was diluted with 500 mL of methanol, after which 0.4 mol of monoethanolamine and 0.4 g of water were added under stirring, and then 0.2 g of polyethylene glycol with a molecular weight of 300,000 was added to prepare a transparent sol. To this were added 5 g of anatase titania particles with a size of approximately 1.2 μm and supporting ruthenium, and these were dispersed ultrasonically and then spray dried, after which the particles were baked at 600° C. The particles thus obtained were observed under an analytical electron microscope, which revealed the surface to be covered with calcia having pores about 200 nm in size. The covered titania particles thus obtained were dispersed in water, after which this dispersion was used to impregnate porous metal and dried. The functional adsorbent thus obtained was examined as follows for its deodorizing effect.

Specifically, 5 g of the above-mentioned functional adsorbent was put in a sealed vessel with a volume of 36 liters, and SOx (used as a harmful substance) was introduced by syringe and adsorbed to saturation, after which the concentration of SOx contained in the sealed vessel was adjusted to 15 ppm, and the contents were irradiated with black light having an intensity of 1 mW/cm². 20 hours later the concentration of SOx contained in the sealed vessel was examined by gas chromatography, which revealed that the SOx concentration had been lowered to 0.7 ppm, and the deodorizing effect was the same as when anatase titania particles whose surface was not covered with calcia were used directly to produce an adsorbent.

An accelerated degradation test was conducted using a carbon arc lamp in order to examine durability, which revealed that when the adsorbent was produced using just anatase titanium oxide not covered with a ceramic inert to light, the adsorbent gradually crumbled to a powder, whereas when the functional adsorbent of this example was used, almost no change was seen, nor was any decrease in performance noted.

### EXAMPLE 25

5 g of brookite titania particles with a size of about 20 nm were added to 500 mL of simulated body fluid (made up of 147 mM Na⁺, 5 mM K⁺, 2.5 mM Ca²⁺, 1.5 mM Mg²⁺, 147 mM Cl⁻, 4.2 mM HCO₃⁻, 1.0 mM HPO₄²⁻, and 0.5 mM SO₄²⁻) , these were dispersed ultrasonically, and the system was allowed to stand at 80° C. to obtain composite particles in which islands of hydroxyapatite were supported on the surface of titania particles. The particles thus obtained were dispersed in water, after which this dispersion was used to impregnate activated carbon and dried. The functional adsorbent thus obtained was examined as follows for its deodorizing effect.

Specifically, 5 g of the above-mentioned functional adsorbent was put in a sealed vessel with a volume of 36 liters, and ammonia (used as a harmful substance) was introduced by syringe and adsorbed to saturation, after which the concentration of ammonia contained in the sealed vessel was adjusted to 120 ppm, and the contents were irradiated with black light having an intensity of 1 mW/cm². 20 hours later the concentration of ammonia contained in the sealed vessel was examined by gas chromatography, which revealed that the ammonia concentration had been lowered to 2 ppm, and the deodorizing effect was the same as when brookite titania particles whose surface was not covered with hydroxyapatite were used directly to produce an adsorbent.

An accelerated degradation test was conducted using a carbon arc lamp in order to examine durability, which revealed that when the adsorbent was produced using just brookite titania particles not covered with a ceramic inert to light, the adsorbent gradually crumbled to a powder, whereas when the functional adsorbent of this example was used, almost no change was seen, nor was any decrease in performance noted. The effect was the same for functional adsorbents in which activated carbon supported composite particles comprising islands of ferrite, titanium phosphate, iron oxide, gypsum, or the like supported on the surface of titania particles.

### Industrial Applicability

As discussed in detail above, the first aspect of the present invention relates to a novel cleaning agent combining at least one member of the group consisting of oxygen-defective titanium oxide TiOₓ (1.5<x<2), titanium oxynitride TiOₓN₂₋ₓ (1<x<2), diamond-like carbon, and a titania-silica complex TiOₓ—SiO₂ (1.5<x≦2), or a covered component produced by partially covering the surface of these with a ceramic, with a thickener and an oxidant as the active components, and to a method for cleaning objects with said cleaning agent. The exceptional effects of the present invention are 1) the above-mentioned cleaning agent has excellent stability, so that an object coated with this cleaning agent may be left in the light and can be used safely and easily, 2) an outstanding cleaning effect is obtained by utilizing sunlight or light from an electric lamp, 3) a novel cleaning method can be provided that involves the use of no synthetic detergent or the like that would cause water pollution and so forth, and 4) because the above-mentioned cleaning agent has an antibacterial effect as well as a deodorizing effect, it can be used in a wide range of cleaning applications, and should have a tremendous effect in industry.

The cleaning agent of the present invention can be utilized in a wide range of cleaning applications, such as the exterior walls of buildings, surfaces of structures, roads, guard rails, mirrors, glass sheets, tile, brick, concrete, block, furniture, bathrooms, bathtubs, verandas, roofs, toilets, teeth, and dentures, as well as the windows and outer surfaces of automobiles, trucks, trains, aircraft, ships, and other such modes of transportation.

The second aspect of the present invention relates to an antibacterial material and an antibacterial product that makes use of this antibacterial material, that not only inhibit the proliferation of microbes, but also decompose these microbes, render them harmless, and remove them, allowing sterilization to be performed effectively, economically, and safely, and furthermore that are also excellent in terms of durability. With the antibacterial material pertaining to the present invention, the surface of a substrate such as oxygen-defective titanium oxide TiOₓ (1.5<x<2), titanium oxynitride TiOₓN₂₋ₓ (1<x<2), diamond-like carbon, or a metal ion-doped titanium oxide is covered with islands of a ceramic that is inert as a photocatalyst, or the surface of titania particles is covered with a ceramic film that has holes in it and is inert as a photocatalyst, resulting in a state in which the substrate is partially covered and partially exposed. Accordingly, any microbes that come into contact with this product can be efficiently killed and continuously decomposed and removed by the redox action of electrons and holes produced on the substrate by irradiation with a fluorescent lamp, incandescent lamp, black light, UV lamp, mercury vapor lamp, xenon lamp, halogen lamp, metal halide lamp, or other such artificial light or sunlight. Also, because it decomposes microbes merely by irradiation with light, the above-mentioned antibacterial material can be used repeatedly, and therefore affords extended use at lower cost and energy consumption and with no maintenance. Also, the ceramic that is inert as a photocatalyst and is composed of alumina, silica, zirconia, zirconium titanate, magnesia, calcia, calcium phosphate, titanium phosphate, iron oxide, ferrite, gypsum, amorphous titania, or the like has an adsorptive action, and this action allows microbes to be adsorbed efficiently. In addition, if a metal such as platinum, rhodium, ruthenium, palladium, silver, copper, iron, or zinc is supported on the surface, the catalytic action of the metal will further enhance the antibacterial and antimildew effect on organic compounds. Furthermore, what can be decomposed is not only microbes, but also other organic compounds that contaminate the environment, such as unpleasant odors and mildew, harmful substances in the air such as NOx, SOx, cigarette smoke, or agrochemical, organic solvents, and so forth dissolved in the water. In addition, it is possible to efficiently clean living environments by preventing soiling and so forth, and prevent nosocomial infection caused by MRSA. The antibacterial product pertaining to the present invention can be manufactured, and the above effects achieved, by kneading in the above-mentioned antibacterial material, or making it into a paint and applying it as a coating, or dispersing it in water or a solvent and spraying it, or dip-coating with it. Even if the product is an organic material, since the portion in contact with the antibacterial material is a ceramic that is inert as a photocatalyst, the substrate tends not to be decomposed, allowing the antibacterial effect to be sustained for an extended period. The antibacterial material and antibacterial product pertaining to the present invention can be used in a wide range of applications, such as the deodorization of automobile interiors, living rooms, kitchens, toilets, and so forth, the treatment of wastewater, and the purification of pool water or stored water, and since they need only be irradiated with light, and do not involve the use of any harmful substances such as chemicals or ozone, they can work effectively with natural light or electric light, and can be used for extended periods at low cost and energy consumption, safely, and without maintenance, and therefore provide a tremendous effect for industrial purposes.

The method for manufacturing an environmental material pertaining to the third aspect of the present invention is an extremely simple method whereby a substrate having a surface composed of titanium oxide is immersed in an aqueous solution containing calcium ions, phosphate ions, and/or hydrogenphosphate ions, and irradiated with microwaves. With this method, a high-performance environmental material comprising hydroxyapatite, apatite carbonate, fluoroapatite, or another such calcium phosphate supported on the surface of a substrate can be manufactured quickly and with little energy. With the environmental material obtained with the manufacturing method of the present invention, the surface of a substrate composed of titanium oxide is partially covered with a porous calcium phosphate film, and the titanium oxide on the substrate surface is irradiated with light, so any organic compounds that contaminate the environment, such as unpleasant odors, harmful substances in the air, or agrochemical, organic solvents, and so forth dissolved in the water can be easily decomposed and removed by the redox action of the electrons and holes produced by the optical irradiation. Also, because the calcium phosphate is porous, the photocatalytic action is substantially the same as that when the substrate is not covered with the calcium phosphate film. Furthermore, since any organic compounds that contaminate the environment are adsorbed, these can be reliably and effectively decomposed and removed by the above-mentioned photocatalytic action.

Therefore, the environmental material of the present invention is extremely effective at decomposing and removing harmful substances present in the air, such as unpleasant odors, cigarette smoke, NOx, or SOx, decomposing and removing organic compounds such as organic solvents and agrochemical dissolved in water, treating wastewater and purifying water, preventing soiling, and other such environmental cleaning applications. Furthermore, the above-mentioned titanium oxide is used in paints, cosmetics, toothpaste, and so forth, has been approved as a food additive, is harmless, safe, and inexpensive, and also has excellent durability and resistance to light.

Further, since a calcium phosphate film has the property of adsorbing proteins, amino acids, bacteria, viruses, and so on, any adsorbed proteins, amino acids, bacteria, viruses, and so on can be reliably and efficiently killed and decomposed by the powerful oxidative action produced by titanium oxide upon irradiation with light. Therefore, if the environmental material pertaining to the present invention is added to a medium such as organic fibers or plastic, it can be applied not only to the deodorization of automobile interiors, living areas, kitchens, toilets, and so forth, the treatment of wastewater, the purification of pool water or stored water, and so on, but also to an extremely wide range of applications such as preventing the proliferation of bacteria and mildew and preventing the spoiling of foods. Furthermore, all that is involved is irradiation with light such as natural light or electric light, with no chemicals, ozone, or other such harmful substances being used, so the environmental material can be used for an extended period at low cost and energy consumption, safely, and without maintenance.

The fourth aspect of the present invention relates to a novel functional adsorbent that not only adsorbs unpleasant odors or harmful substances in the air, but also decomposes and removes them, and allows an environment to be cleaned effectively, economically, and safely, and is also very durable, and a method for manufacturing this functional adsorbent. The titania used in the present invention is used in paints, cosmetics, toothpaste, and so forth, has been approved as a food additive, is inexpensive, has excellent weather resistance durability, and is harmless and safe, among its numerous advantages. With the functional adsorbent of the present invention, titania particles are supported on a porous material, and the surface of these titania particles is covered with islands of a ceramic that is inert as a photocatalyst, or the surface of the titania particles is covered with a ceramic film that is inert as a photocatalyst and has holes in it, and is therefore only partially covered, and the titania is partially exposed. Accordingly, when the titania is irradiated with sunlight or artificial light from a fluorescent lamp, incandescent lamp, black light, UV lamp, mercury vapor lamp, xenon lamp, halogen lamp, metal halide lamp, or the like, the redox action of the electrons and holes produced in the titania decomposes any organic compounds contaminating an environment, such as unpleasant odors of cigarette smoke, harmful substances such as NOx or SOx in the air, or organic solvents, agrochemical, or the like dissolved in water, that are adsorbed by the porous material of the substrate, and also prevents nosocomial infection caused by MRSA and cleans living environments by preventing soiling and so forth. Also, organic compounds contaminating an environment an be efficiently adsorbed by the adsorption action of the ceramic that is inert as a photocatalyst, such as alumina, silica, zirconia, zirconium titanate, magnesia, calcia, calcium phosphate (apatite), titanium phosphate, iron oxide, ferrite, gypsum, or amorphous titania. In addition, if a metal such as platinum, rhodium, ruthenium, palladium, silver, copper, iron, or zinc is supported on the surface of the titania particles, the catalytic action of this metal will further enhance the environmental cleaning effect, such as the decomposition and removal of organic compounds, or an antibacterial or antimildew effect. Furthermore, since the portion in contact with the porous material of the activated carbon or other substrate is a ceramic that is inert as a photocatalyst, the substrate is resistant to decomposition and the effect can be sustained for an extended period of time. The functional adsorbent of the present invention can be used effectively not only in the deodorization of automobile interiors, living rooms, kitchens, toilets, and so forth, the treatment of wastewater, and the purification of pool water or stored water, but also in preventing the proliferation of bacteria and mildew and preventing the spoiling of foods, for example, and therefore has a wide range of applications. Furthermore, all that is involved is irradiation with light such as natural light or electric light, with no chemicals, ozone, or other such harmful substances being used, so the functional adsorbent can be used for an extended period at low cost and energy consumption, safely, and without maintenance.

1. A cleaning agent, comprising:
diamond-like carbon, or a covered component produced by partially covering the surface thereof with a ceramic;
a thickener; and
an oxidant.

2. The cleaning agent according to claim 1, wherein the thickener is an inorganic layered compound.

3. The cleaning agent according to claim 1, wherein the oxidant is at least one type selected from the group consisting of oxygen, ozone, hydrogen peroxide, and other peroxides.

4. The cleaning agent according to claim 1, wherein the cleaning agent is a solution or a paste.

5. A cleaning method, wherein a target object is coated with a cleaning agent comprising diamond-like carbon, or a covered component produced by partially covering the surface thereof with a ceramic, and a thickener and an oxidant, and then irradiated with light so that the surface of the target object is cleaned by photocatalytic action.

6. The cleaning method according to claim 5, wherein the irradiation is with light that includes visible light.

7. The cleaning method according to claim 5, wherein the thickener is an inorganic layered compound.

8. The cleaning method according to claim 5, wherein the oxidant is at least one type selected from the group consisting of oxygen, ozone, hydrogen peroxide, and other peroxides.

9. An antibacterial material, wherein the surface of a substrate composed of diamond-like carbon is partially covered with a ceramic that is inert to light.

10. The antibacterial material according to claim 9, wherein the ceramic that is inert to light is at least one type of ceramic selected from the group consisting of alumina, silica, zirconia, zirconium titanate, magnesia, calcia, calcium phosphate, titanium phosphate, iron oxide, ferrite, gypsum, and amorphous titania.

11. An antibacterial liquid, containing an antibacterial material in which the surface of a substrate composed of diamond-like carbon is partially covered with a ceramic that is inert to light.

12. The antibacterial liquid according to claim 11, wherein the ceramic that is inert to light is at least one type of ceramic selected from the group consisting of alumina, silica, zirconia, zirconium titanate, magnesia, calcia, calcium phosphate, titanium phosphate, iron oxide, ferrite, gypsum, and amorphous titania.

13. An antibacterial product, containing an antibacterial material in which the surface of a substrate composed of diamond-like carbon is partially covered with a ceramic that is inert to light.

14. The antibacterial product according to claim 13, wherein the ceramic that is inert to light is at least one type of ceramic selected from the group consisting of alumina, silica, zirconia, zirconium titanate, magnesia, calcia, calcium phosphate, titanium phosphate, iron oxide, ferrite, gypsum, and amorphous titania.

15. The antibacterial product according to claim 13, being at least one type selected from the group consisting of antibacterial bath products, antibacterial textile products, antibacterial artificial plants, antibacterial plastic products, antibacterial paper products, antibacterial paints, and antibacterial wood and bamboo products.

16. A method for manufacturing an environmental material, wherein a substrate having a surface composed of titanium oxide is immersed in an aqueous solution containing calcium ions, phosphate ions, and/or hydrogenphosphate ions, and irradiated with microwaves, thereby producing calcium phosphate on the surface of the substrate in a short time, and manufacturing quickly and with little energy an environmental material in which porous calcium phosphate is supported on the surface of this substrate.

17. The method for manufacturing an environmental material according to claim 16, wherein after the substrate is immersed in an aqueous solution containing calcium ions, phosphate ions, and/or hydrogenphosphate ions, and irradiated with microwaves, it is dried at 40 to 600° C.

18. The method for manufacturing an environmental material according to claim 16 or 17, wherein the calcium ion concentration is 0.5 to 100 mM, and the concentration of phosphate ions and/or hydrogenphosphate ions is 1 to 50 mM.

19. The method for manufacturing an environmental material according to claim 16, 17, or 18, wherein the pH of the solution in which the substrate is immersed is from 6 to 9.

20. The method for manufacturing an environmental material according to claim 16, 17, 18, or 19, wherein the frequency of the microwaves is 2.45 GHz.

21. An environmental cleaning product, wherein a substrate having a surface composed of titanium oxide is immersed in an aqueous solution containing calcium ions, phosphate ions, and/or hydrogenphosphate ions, and irradiated with microwaves, thereby porous calcium phosphate being supported on the surface of this substrate.

22. A functional adsorbent, wherein the surface of titania particles is partially covered with a ceramic that is inert to light, and the resulting covered titania particles are supported on a porous material, by partially covering the surface of titania particles with a ceramic that is inert to light, dispersing the resulting covered titania particles in a solvent, covering a porous material having a substance adsorption function with this dispersion and drying, so that the photocatalyst is supported on the porous material of the substrate via the ceramic that is inert to light.

23. The functional adsorbent according to claim 22, wherein the ceramic that is inert to light is at least one type of ceramic selected from the group consisting of alumina, silica, zirconia, zirconium titanate, magnesia, calcia, calcium phosphate, titanium phosphate, iron oxide, ferrite, gypsum, and amorphous titania.

24. The functional adsorbent according to claim 22, wherein the titania particles are produced by supporting at least one type of metal selected from the group consisting of platinum, rhodium, ruthenium, palladium, silver, copper, iron, and zinc on the surface of titania particles.

25. The functional adsorbent according to claim 22, wherein the porous material is at least one type selected from the group consisting of activated carbon, foamed plastic, molded glass fiber, molded synthetic fiber, molded FRP, molded plastic-inorganic composite, molded fiber, activated alumina, zeolite, porous glass, porous metal, porous ceramic, molded clay, and a molded inorganic layered compound.

26. The functional adsorbent according to claim 22 or 24, wherein the crystal form of the titania particles is anatase or brookite.

27. A method for manufacturing a functional adsorbent, wherein the surface of titania particles is partially covered with a ceramic that is inert to light, and the resulting covered titania particles are dispersed in a solvent, and then used to cover a porous material having a substance adsorption function, and dried, so that the photocatalyst is supported on the porous material of the substrate via the ceramic that is inert to light.
